(19) United States
(12) Patent Application Publication
(10) Pub. No.: US 2025/0066606 A1
(43) Pub. Date: Feb. 27, 2025

(54) Rotationally Molded Articles For Food Contact Applications

(71) Applicant: Celanese International Corporation, Irving, TX (US)

(72) Inventors: Darin Grinsteinner, Fort Mitchell, KY (US); Adam Larkin, Dallas, TX (US)

(21) Appl. No.: 18/813,218

(22) Filed: Aug. 23, 2024

Related U.S. Application Data
(60) Provisional application No. 63/578,184, filed on Aug. 23, 2023.

(51) Int. Cl. C08L 71/02; B65D 1/22; B65D 65/38; B65D 85/50; C08K 5/098; C08L 67/02; C08L 75/04

(52) U.S. Cl. CPC C08L 71/02; B65D 1/22; B65D 65/38; B65D 85/50; C08K 5/098; C08L 67/02; C08L 75/04

(57) ABSTRACT

A polymer composition containing a polyoxymethylene polymer in the form of particles for rotational molding applications is disclosed. The polyoxymethylene polymer is selected to have physical characteristics and is combined with one or more impact modifiers in order to produce hollow vessels and other articles having improved physical properties, such as impact strength resistance. The polymer composition of the present disclosure is particularly formulated so as to be food contact grade compliant.

### RELATED APPLICATIONS

The present application is based upon and claims priority to U.S. Provisional Patent Application Ser. No. 63/578,184, having a filing date of Aug. 23, 2023, which is incorporated herein by reference.

### BACKGROUND

Hollow vessels can be made using various different types of molding processes and techniques. One particular type of process is referred to as rotational molding. During rotational molding, a polymer material is placed in a mold and heated above its softening temperature causing the polymer material to become molten and flow. During the heating process, the mold is rotated about at least one axis, and typically about at least two different axes. The centrifugal force causes the polymer material to line the walls of the mold and form a hollow vessel. Rotational molding offers various advantages because the process can produce seamless hollow products with high complexity. The processing window of the polymer material, however, has limited the use of rotational molding to particular types of polymers, such as polyethylene polymers and polyamide polymers.

In some applications, the hollow vessels being formed through rotational molding include bins or containers that are designed to contact and hold foodstuffs. In these applications, the polymer composition used to form the rotationally molded article needs to meet all government regulations regarding food contact. Consequently, many polymers and many polymer compositions do not meet governmental regulations and thus have not been used to produce food contact containers and other articles. For instance, most polyethylene polymer grades are not capable of being used to produce rotationally molded articles designed for food contact applications.

In view of the above, in the past, most rotationally molded food contact articles were formed from polypropylene polymers. Rotationally molded articles made from polypropylene polymers, however, have various drawbacks and deficiencies. For instance, polypropylene polymers display relatively poor impact strength and have a tendency to display stress whitening and failures during handling. Polypropylene polymers are also susceptible to staining, especially when contacting various different food types. In addition to problems associated with staining, polypropylene polymers also experience odor retention problems. Further, polypropylene polymers are somewhat difficult to rotationally mold producing significant amounts of scrap waste during production of the articles.

In view of the above, a need currently exists for a food contact grade polymer that can replace the use of polypropylene polymers and other polymers currently being utilized in the industry. One particular class of polymers that have excellent strength, temperature resistance, and chemical resistance are polyoxymethylene polymers. Polyoxymethylene polymers, however, are typically blended with various other components, such as impact modifiers, formaldehyde scavengers, light stabilizers, and the like, that are not food contact grade compliant. Thus, various obstacles have existed in the ability to incorporate polyoxymethylene polymers into food contact grade resins designed to produce rotationally molded articles.

In view of the above, a need currently exists for a polyoxymethylene polymer composition that is well suited for producing rotationally molded articles and meets all food contact government regulations. In one aspect, for instance, a need exists for an impact modified polyoxymethylene polymer resin and rotationally molded articles made from the resin that not only meet all food grade regulations but also include at least one impact modifier that improves the impact resistance of articles made from the resin. In addition, a need exists for a polyoxymethylene polymer composition well suited to producing rotationally molded articles that includes at least one color agent and that is resistant to fading.

### SUMMARY

The present disclosure is generally directed to polyoxymethylene polymer compositions particularly well suited not only for rotational molding applications but also for food contact applications. The polymer composition of the present disclosure, for instance, can be formulated such that all components contained in the composition are approved for food contact use while also producing a composition that has good impact resistance properties and low formaldehyde extractable levels.

The present disclosure is also generally directed to polyoxymethylene polymer compositions that contain at least one coloring agent and are resistant to fading. In one aspect, the polyoxymethylene polymer composition can contain one or more coloring agents that are incorporated into the composition in a manner that does not adversely impact the mechanical properties of the composition when formed into rotationally molded articles. A fade-resistant polyoxymethylene polymer composition is not only well suited for use in food contact applications, but also has broader applicability for producing rotationally molded articles in other fields.

In one aspect, the present disclosure is directed to a polyoxymethylene polymer composition. The polymer composition is particularly well suited for rotational molding applications and is comprised of polymer particles. The polymer particles comprise a polyoxymethylene polymer blended with an impact modifier. The impact modifier, for instance, can be food grade approved and meet the requirements of European Food Regulation 10/2011 and FDA Food Regulation FDA 21 CFR 177.2470. The impact modifier can comprise any suitable thermoplastic elastomer. The polyoxymethylene polymer can have a melt flow rate of less than about 10 g/10 min, such as less than about 5 g/10 min and can be present in the polymer composition in an amount of at least about 55% by weight. The impact modifier can be present in the polymer composition in an amount from about 4% by weight to about 27% by weight. The polymer particles can further comprise a nucleant and/or an antioxidant. The polymer particles can have an average particle size of from about 250 microns to about 800 microns.

The impact modifier, in one aspect, can be a thermoplastic polyurethane elastomer. The impact modifier, for instance, can comprise a polyester polyurethane. The thermoplastic polyurethane elastomer can have a melt flow rate of greater than about 7 g/10 min, such as greater than about 8 g/10 min, such as greater than about 9 g/10 min, and less than about 25 g/10 min, such as less than about 20 g/10 min, such as less than about 18 g/10 min, such as less than about 15 g/10 min when measured at 190° C. and at a load of 2.16 kg. The thermoplastic polyurethane elastomer can have a melt flow rate of greater than about 20 g/10 min, such as greater than about 30 g/10 min, such as greater than about 40 g/10 min, such as greater than about 45 g/10 min, and less than about 70 g/10 min, such as less than about 60 g/10 min, such as less than about 55 g/10 min when tested at 190° C. and at a load of 8.7 kg according to ISO Test 1131-1.

The thermoplastic polyurethane elastomer can have a melting temperature of from about 150° C. to about 180° C. The thermoplastic polyurethane elastomer can display a Shore A hardness of greater than about 78, such as greater than about 80, such as greater than about 82, such as greater than about 84, and less than about 95, such as less than about 92, such as less than about 89, when measured according to ASTM Test D2240.

The impact modifier, in one aspect, can be a thermoplastic polyester elastomer. The impact modifier, for instance, can comprise a polyetherester. The thermoplastic polyester elastomer can have a melt flow rate of greater than about 7 g/10 min, such as greater than about 8 g/10 min, such as greater than about 9 g/10 min, and less than about 25 g/10 min, such as less than about 20 g/10 min, such as less than about 18 g/10 min, such as less than about 15 g/10 min when measured at 190° C. and at a load of 2.16 kg. The thermoplastic polyester elastomer can have a melt flow rate of greater than about 20 g/10 min, such as greater than about 30 g/10 min, such as greater than about 40 g/10 min, such as greater than about 45 g/10 min, and less than about 70 g/10 min, such as less than about 60 g/10 min, such as less than about 55 g/10 min when tested at 190° C. and at a load of 8.7 kg according to ISO Test 1131-1.

The thermoplastic polyester elastomer can have a melting temperature of from about 150° C. to about 180° C. The thermoplastic polyester elastomer can display a Shore A hardness of greater than about 78, such as greater than about 80, such as greater than about 82, such as greater than about 84, and less than about 95, such as less than about 92, such as less than about 89, when measured according to ASTM Test D2240.

As described above, the polymer composition can contain a nucleant. The nucleant, in one embodiment, can be a terpolymer. Alternatively, the nucleant can be a mineral nucleant, such as talc. In one aspect, the polymer composition does not contain any ultraviolet light stabilizers and is free of guanamine, urea, or melamine formaldehyde scavengers.

The polymer composition can contain an acid scavenger, such as a carboxylic acid salt. The carboxylic acid salt can comprise an alkaline earth metal salt of a carboxylic acid. For example, the acid scavenger can comprise a calcium citrate, a calcium propionate, or mixtures thereof. The acid scavenger can be present in the polymer composition in an amount from about 0.001% by weight to about 1% by weight. In one particular aspect, the polymer composition contains calcium propionate and tricalcium citrate. The calcium propionate can be present in relation to the tricalcium citrate at a weight ratio of from about 4:1 to about 1.2:1.

In one aspect, one or more acid scavengers can be present in the composition in a relatively low amount. For instance, one or more acid scavengers or calcium salts can be present in the polymer composition in an amount less than about 0.1% by weight, such as in an amount less than about 0.08% by weight, such as in an amount less than about 0.06% by weight, and in an amount greater than about 0.01% by weight.

The polymer composition may also contain a plasticizer in relatively minor amounts. For instance, the plasticizer can comprise a polyethylene glycol. The plasticizer can be present in an amount from about 0.01% by weight to about 2% by weight, such as from about 0.1% by weight to about 0.8% by weight.

In one aspect, the polymer composition may be free of plasticizers, and may not contain any polyethylene glycol components. For example, in one application, the polymer composition can be formulated to be free of plasticizers for enhancing one or more mechanical properties, such as impact strength.

In another embodiment, the present disclosure is directed to a polymer composition for rotational molding applications. The polymer composition contains polymer particles comprising a polyoxymethylene polymer blended with an impact modifier. The impact modifier can comprise a thermoplastic elastomer. The polyoxymethylene polymer can have a melt flow rate of less than about 20 g/10 min, such as less than about 15 g/10 min, such as less than about 10 g/10 min, such as less than about 5 g/10 min. The impact modifier can be present in the polymer composition in an amount from about 4% by weight to about 27% by weight. The polymer composition can be in the form of particles having an average particle size of from about 250 microns to about 800 microns. The polymer composition can further contain at least one coloring agent. The coloring agent can be incorporated into the polymer composition as a masterbatch containing the coloring agent combined with a polymer. The polymer can comprise, for instance, a polyoxymethylene polymer or a polyolefin polymer, such as a polyethylene polymer.

The polymer composition can also optionally contain one or more ultraviolet light stabilizers. In accordance with the present disclosure, the polymer composition can display a Delta E color shift according to SAE Test J2527 of less than about 10, such as less than about 7, such as less than about 5, such as less than about 3, such as less than about 2.5, such as less than about 2, such as less than about 1.5 when tested at 500 kJ/m².

The polymer composition can further contain at least one coloring agent. The coloring agent can comprise a yellow coloring agent, a blue coloring agent, a red coloring agent, an orange coloring agent, a green coloring agent, a white coloring agent, a black coloring agent, or mixtures thereof. In one aspect, the coloring agent comprises a carbon black or graphite combined with a carrier polymer. The carrier polymer can be present in the masterbatch in an amount from about 1% by weight to about 60% by weight. The coloring agent, such as carbon black, can be present in the polymer composition in an amount less than about 2% by weight, such as in an amount less than about 1.5% by weight, such as in an amount less than about 1% by weight, such as in an amount less than about 0.5% by weight, while still displaying fade resistance or low Delta E properties as described above.

In another aspect, the present disclosure is directed to a rotationally molded container, such as a food contact article. The food contact article can comprise a seamless, rotationally molded food container defining an interior space for contacting foodstuffs. The food container can comprise a wall made from the polymer composition as described above. For example, the food contact article can comprise a food bin, a beverage cooler, or the like. In alternative embodiments, the rotationally molded article made according to the present disclosure, can comprise any suitable tote or large tank for any suitable application. The wall can have a thickness of from about 0.5 mm to about 10 mm. The container can have an interior volume of greater than about 3 gallons, such as greater than about 5 gallons, such as greater than about 10 gallons, such as greater than about 20 gallons, such as greater than about 40 gallons, such as greater than about 60 gallons, such as greater than about 100 gallons, and less than about 800 gallons, such as less than about 500 gallons, such as less than about 400 gallons, such as less than about 300 gallons, such as less than about 200 gallons.

Rotationally molded articles made according to the present disclosure can display excellent properties. For instance, the rotationally molded article or polymer composition used to make the article can display a Charpy notched impact strength at 23° C. according to ISO Test 179 of greater than about 9 kJ/m², such as greater than about 10 kJ/m², such as greater than about 12 kJ/m², such as greater than about 14 kJ/m², and less than about 90 kJ/m². The polymer composition can display a heat deflection temperature at 0.45 MPa according to ISO Test 75 of greater than about 100° C., such as greater than about 110° C., such as greater than about 120° C., such as greater than about 130° C., and less than about 160° C. The polymer composition can display a tensile yield strength according to ISO Test 527 of greater than about 30 MPa, such as greater than about 35 MPa, such as greater than about 38 MPa, and less than about 80 MPa. The wall of the food container can have a density according to ISO Test 1183 of greater than about 1 g/cc, such as greater than about 1.1 g/cc, such as greater than about 1.2 g/cc, such as greater than about 1.3 g/cc, and less than about 1.6 g/cc. The polymer composition used to form the food contact article can display a melt flow rate of greater than about 1 g/10 min and less than about 10 g/10 min, such as from about 1 g/10 min to about 6 g/10 min, such as from about 2 g/10 min to about 4.5 g/10 min.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a perspective view of one embodiment of a rotationally molded article made in accordance with the present disclosure; and

FIG. 2 is a perspective view of another embodiment of a rotationally molded article made in accordance with the present disclosure.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only and is not intended as limiting the broader aspects of the present disclosure.

In general, the present disclosure is directed to a polyoxymethylene polymer composition in the form of particles that is particularly well suited for use in rotational molding applications. In accordance with the present disclosure, the polyoxymethylene polymer composition can be formulated such that the composition meets all requirements and governmental regulations necessary for the polymer composition to be used in food contact applications. Thus, the present disclosure is also directed to rotationally molded articles that are particularly well suited for holding and/or contacting foodstuffs.

The polymer composition of the present disclosure is not limited to food applications. For instance, in one embodiment, the polymer composition can be formulated so as to have excellent color fade resistance while still retaining significant mechanical properties, including impact properties. A composition with color fade resistance is not only well suited for food contact applications, but also suited in virtually all other fields.

Polymer compositions and rotationally molded articles made according to the present disclosure offer various benefits and advantages, especially in comparison to polypropylene polymers used in the past. For instance, the polymer composition can contain a food contact compliant impact modifier that not only produces articles with excellent impact strength resistance but can also be incorporated into the polymer composition without experiencing phase separation during rotational molding applications. In this manner, relatively large food containers or hollow vessels can be produced from a single layer of the polymer composition while having decreased stiffness and enhanced impact resistance. In addition, rotationally molded articles made according to the present disclosure do not exhibit stress cracking that is typically found in polypropylene polymers. In addition, the rotationally molded articles are stain resistant and do not experience odor retention problems. Further, the polymer composition of the present disclosure can withstand higher temperatures that many polymers used in the past, which is especially helpful when washing and/or sterilizing the articles in between uses.

It was also discovered that the polymer composition of the present disclosure will accept coloring agents, such as pigments and dyes. Thus, rotationally molded polymer articles can be produced according to the present disclosure that can exhibit various different colors. In this manner, color can be used to identify the rotationally molded articles for particular applications and to distinguish them from other similar looking articles that may be used to hold different items or products. The polymer composition of the present disclosure has been found well suited to accepting different coloring agents without sacrificing any mechanical properties.

In one aspect, for instance, one or more coloring agents can be incorporated into the polymer composition in a manner that produces colored molded articles with enhanced fade resistance. These fade-resistant properties can be produced with nearly any color, even black. For example, in the past, being able to produce a black composition that had color fade resistance was a significant problem. According to the present disclosure, however, color fade resistance can be achieved even when using black coloring agents at very small amounts. For instance, polymer compositions formulated in accordance with the present disclosure can display a Delta E color shift when tested according to SAE Test J2527 at 500 kJ/m² of less than about 10, such as less than about 9, such as less than about 8, such as less than about 7, such as less than about 6, such as less than about 5, such as less than about 4, such as less than about 3, such as less than about 2.5, such as less than about 2, such as less than about 1.5.

In addition to the above, the use of a polyoxymethylene polymer for rotational molding processes can offer various advantages and benefits. Polyoxymethylene copolymers, for instance, possess a linear structure with a highly crystalline quality that provides a variety of characteristics including outstanding wear, long-term fatigue, toughness and creep resistance as well as excellent resistance to moisture, solvents, and strong alkalis. The chemical structure of polyoxymethylene polymers provides a higher stability to thermal and oxidative degradation compared to many different polymers. The use of a polyoxymethylene copolymer is, in fact, more thermally stable and resistant to degradation than a polyoxymethylene homopolymer. The polyoxymethylene polymer is formulated to increase the impact resistance while maintaining excellent permeability characteristics.

As described above, the polymer composition of the present disclosure is in the form of a powder. The powder composition has a controlled particle size distribution that has been found to provide advantages and benefits during rotational molding processes. For instance, the powder can have fluid-like flow properties. Thus, the polymer composition can be easy to handle for loading into the mold and will circulate uniformly within the mold during rotation of the mold. The particle size distribution, for instance, can lead to the formation of articles with greater accuracy and tolerances.

The particle size distribution in combination with the combination of different components that make up the polymer composition can also produce a polymer composition with lower shrinkage and less internal stress during the molding process. The particle size distribution in combination with the formulation also provide for a relatively large operating window during the molding process. For example, the polymer composition has thermal properties that make the composition well suited for longer cycle time with greater stability. In this manner, the polymer composition, once molten, flows uniformly over the surface of the mold and produces molded articles with little to no voids.

In one aspect, the powder composition can have a D₅₀ average particle size of generally greater than 250 microns, such as greater than about 300 microns, such as greater than about 350 microns, such as greater than about 400 microns. The D₅₀ particle size is generally less than about 800 microns, such as less than about 750 microns, such as less than about 700 microns, such as less than about 650 microns.

Particle size can be determined using a laser scattering particle size distribution analyzer, such as a Beckman Coulter LS 13 320 particle size analyzer.

In another embodiment, the particle size distribution of the polymer composition can be such that 90% of the particles have a size less than about 800 microns, such as less than about 750 microns. 50% of the particles by mass can have a particle size of from about 250 microns to about 600 microns. In addition to using light scattering for determining particle size, in an alternative embodiment, a sieve test can be used. For example, particle size (based on mass) can be determined using a RO-TAP sieve shaker.

As described above, the polymer composition of the present disclosure can be formulated such that each ingredient or component contained in the composition is food contact grade compliant. In this regard, a food contact compliant polyoxymethylene polymer is combined with a food contact grade compliant impact modifier, which can comprise an elastomer. The impact modifier is not only food contact grade compliant but is also selected so as to have various properties that make the impact modifier not only well suited for blending with a polyoxymethylene polymer but also for being used in a rotational molding processes. The polymer composition of the present disclosure can also contain a nucleant. The nucleant can increase crystallinity, stiffness and the heat deflection temperature. By increasing crystallinity, the polymer composition is better suited for grinding processes for producing particles having not only a desired size but a uniform size.

In addition to containing the above components, the polymer composition can also be formulated to avoid using certain ingredients and components. For instance, the polymer composition can be formulated without containing conventional formaldehyde scavengers, such as guanamine, urea, melamine, and derivatives thereof. The polymer composition can also be formulated so as to be free of various light stabilizers, particularly ultraviolet light stabilizers. In another aspect, however, the polymer composition can be formulated so as to contain ultraviolet light stabilizers. One or more ultraviolet light stabilizers, for instance, can be incorporated into the polymer composition in an amount less than about 2% by weight, such as in an amount less than about 1.5% by weight, such as in an amount less than about 1% by weight, such as in an amount less than about 0.8% by weight, and in an amount greater than about 0.01% by weight. Adding one or more ultraviolet light stabilizers, for instance, can be one factor in controlling color fade resistance. The manner in which the components are added together and the components that are present can also lead significantly to the color fade resistance properties.

The polymer composition of the present disclosure can be formulated to meet all different types of food contact government regulations. For instance, the polymer composition can be formulated to be food contact compliant according to United States law and/or European law.

Title 21 CFR deals generally with food and drugs. In particular, 21 CFR § 177.2470 and § 177.2480 address POM copolymers and homopolymers, respectively. Compliant adjuvants may be added, such as stabilizers or pigments. The POM polymers may not yield net chloroform-soluble extractives exceeding 0.5 mg/in² of food contact area and are restricted to use in temperatures not exceeding 250° F. Extractives are prepared according to the simulated use scenarios set forth in 21 CFR § 175.300 (d) and repeated below:

TABLE 1
Types of food.

| Label | Type of Food |
|---|---|
| I | Nonacid (pH above 5.0), aqueous products; may contain salt or |
| | sugar or both, and including oil-in-water emulsions of low- or |
| | high-fat content. |
| II | Acidic (pH 5.0 or below), aqueous products; may contain salt or |
| | sugar or both, and including oil-in-water emulsions of low- or |
| | high-fat content. |
| III | Aqueous, acid or nonacid products containing free oil or fat; may |
| | contain salt, and including water-in-oil emulsions of low- or |
| | high-fat content. |
| IV | Dairy products and modifications: |
| IV-A | Water-in-oil emulsion, high- or low-fat. |
| IV-B | Oil-in-water emulsion, high- or low-fat. |
| V | Low moisture fats and oils. |
| VI | Beverages: |
| VI-A | Containing alcohol. |
| VI-B | Nonalcoholic. |
| VII | Bakery products. |
| VIII | Dry solids (no end test required). |

TABLE 2
Test Procedures for determining amount of extractives from resinous or
polymeric coatings using solvents simulating types of food and beverages.

| | Types of Food | Extractant | | |
|---|---|---|---|---|
| Condition of Use | (See Table 1) | Water | Heptane¹ | 8% Alcohol |
| A. High temperature heat- | I, IV-B . . . | 250° F., 2 hr | | |
| sterilized (e.g. over 212° F.) | III, IV-A, VII . . . | 250° F., 2 hr . . . | 150° F., 2 hr | |
| B. Boiling water-sterilized | II . . . | 212° F., 30 min | | |
| | III, VII . . . | 212° F., 30 min . . . | 120° F., 30 min | |
| C. Hot filled or pasteurized | II, IV-B . . . | Fill boiling, cool to 100° F. | | |
| above 150° F. | III, IV-A . . . | Fill boiling, cool to 100° F. | 120° F., 30 min | |
| | V . . . | . . . | 120° F., 30 min | |
| D. Hot filled or pasteurized | II, IV-B, VI-B . . . | 150° F., 2 hr | | |
| below 150° F. | III, IV-A . . . | 150° F., 2 hr . . . | 100° F., 30 min | |
| | V . . . | . . . | 100° F., 30 min | |
| | VI-A . . . | . . . | . . . | 150° F., 2 hr |
| E. Room temperature filled | II, IV-B, VI-B . . . | 120° F., 24 hr | | |
| and stored (no thermal | III, IV-A . . . | 120° F., 24 hr . . . | 70° F., 30 min | |
| treatment in the container) | V, VII . . . | . . . | 70° F., 30 min | |
| | VI-A . . . | . . . | . . . | 120° F., 24 hr |
| F Refrigerated storage (no | I, II, III, IV-A, | | | |
| thermal treatment in the | IV-B, VI-B, VII . . . | 70° F., 48 hr | | |
| container) | VI-A . . . | . . . | . . . | 70° F., 48 hr |
| G. Frozen storage (no | I, II, III, IV-B, VII . . . | 70° F., 24 hr | | |
| thermal treatment in the | | | | |
| container) | | | | |
| H. Frozen storage: Ready | | | | |
| prepared foods intended to | | | | |
| be reheated in container at | | | | |
| time of use: | | | | |
| 1. Aqueous or oil | I, II, IV-B . . . | 212° F., 30 min | | |
| in water emulsion | | | | |
| of high or low fat. | | | | |
| 2. Aqueous, high | III, IV-A, VII . . . | 212° F., 30 min . . . | 120° F., 30 min | |
| or low free oil or fat. | | | | |

¹Heptane extractant not to be used on wax-lined containers. Heptane extractivity results must be divided by a factor of five in arriving at the extractivity for a food product.

21 CFR § 177.2470 and § 177.2480 detail further requirements for POM polymers. The POM polymers, with or without any adjuvants, when ground or cut into particles that pass through a U.S.A. Standard Sieve No. 6 and that are retained on a U.S.A. Standard Sieve No. 10, should yield total extractives not to exceed (i) 0.2 wt. % when extracted for 6 hours in distilled water at reflux temperature, (ii) 0.15 wt. % when extracted for 6 hours in n-heptane at reflux temperature. POM homopolymers should not yield formaldehyde in an amount exceeding 0.005 wt. %. Additionally, POM homopolymers should contain stabilizers in an amount no more than 1.9 wt. %. The minimum number average molecular weight of the copolymer is 25000, with a density between 1.39 and 1.44 g/cm³ and a melting point between 172° C. and 184° C. Approved POM copolymers may be the reaction product of trioxane and either ethylene oxide or up to 5 wt. % butanediol formal. The minimum number average molecular weight of the copolymer is 15000. Approved copolymers should contain no more than 2.0 wt. % stabilizers, no one stabilizer amount being more than 1.0 wt. %.

The European regulations for polymer food contact standards are found in EC 10/2011. Similar to 21 CFR, the regulation lists a number of simulated scenarios and materials to provide test conditions mimicking the realistic worst-case scenario of the proposed use of the material, for example Tables 1 and 2 of ANNEX V detail contact times and temperatures of the test scenarios using the simulated extractants listed in Table 1 of ANNEX III.

EC 10/2011 also lists total migration limitations for a variety metals per mass of food or food simulant: Barium, 1 ppm; Cobalt, 0.05 ppm; Copper, 5 ppm; Iron, 48 ppm; Lithium, 0.6 ppm; Manganese, 0.6 ppm; and Zinc, 25 ppm. Primary aromatic amines not listed in Table 1 of ANNEX I must not be released in detectable amounts (less than 0.01 ppm).

Various EU publications have further defined restrictions on additives, such as for colorants (color additives). For instance, EC 10/2011 restricts carbon black amounts to no more than 2.5 wt. % with no more than 0.25 ppm benzo (a) pyrene and the toluene-extractable fraction not exceeding 0.1 wt. %. As will be described in greater detail below, carbon black can be incorporated into the polymer compositions of the present disclosure in relatively low amounts, such as in amounts less than about 1% by weight, such as less than about 0.8% by weight while still producing articles having a vibrant black color with little to no color fade after exposure to UV light.

For example, AP (89) 1 defines the metals and metalloids in colorants may be soluble in 0.1M HCl in amounts no more than the following: Antimony, 0.05 wt. %; Arsenic, 0.01 wt. %; Barium, 0.01 wt. %; Cadmium, 0.01 wt. %; Chromium, 0.1 wt. %; Lead, 0.01 wt. %; Mercury, 0.005 wt. %; and selenium, 0.01 wt. %. Primary aromatic amines in the colorants soluble in 1M HCl and expressed as aniline should be present in amounts not exceeding 500 ppm. Carbon black, in particular, must not contain a toluene-extractable fraction exceeding 0.15 wt. %. Extractable polychlorinated biphenyls should not exceed 25 ppm.

Germany BfR IX defines the same metal purity limitations as AP (89) 1 and additionally requires that the colorants are required to withstand temperature ranges from approximately 150° C. to approximately 300° C. while the plastic is being processed.

Spain Real Decreto 847/2011 defines the same metal purity limitations as AP (89) 1, except specifying 0.1N HCl.

Italy Decreto 21/3/73 defines the same metal purity limitations as AP (89) 1, except specifying 0.1N HCl and further restricting arsenic to no more than 0.005 wt. %.

In some embodiments, a polymer composition is formulated to meet at least one of the above-mentioned certifications by careful attention to and selection of processing parameters and composition ingredients. For example, the preparation of the polyoxymethylene polymer and the selection of any additives (e.g. color additives) may be uniquely manipulated to produce a final product (e.g. a material, device component, or finished device) adhering to at least one of the above-mentioned standards.

As described above, in one aspect, the primary ingredient or matrix polymer contained in the polymer composition is a polyoxymethylene polymer. The preparation of the polyoxymethylene polymer can be carried out by polymerization of polyoxymethylene-forming monomers, such as trioxane or a mixture of trioxane and a cyclic acetal such as dioxolane in the presence of a molecular weight regulator, such as a glycol. According to one embodiment, the polyoxymethylene is a homo- or copolymer which comprises at least 50 mol. %, such as at least 75 mol. %, such as at least 90 mol. % and such as even at least 97 mol. % of —CH₂O-repeat units.

In one embodiment, a polyoxymethylene copolymer is used. The copolymer can contain from about 0.1 mol. % to about 20 mol. % and in particular from about 0.5 mol. % to about 10 mol. % of repeat units that comprise a saturated or ethylenically unsaturated alkylene group having at least 2 carbon atoms, or a cycloalkylene group, which has sulfur atoms or oxygen atoms in the chain and may include one or more substituents selected from the group consisting of alkyl cycloalkyl, aryl, aralkyl, heteroaryl, halogen or alkoxy. In one embodiment, a cyclic ether or acetal is used that can be introduced into the copolymer via a ring-opening reaction.

Preferred cyclic ethers or acetals are those of the formula:

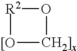

in which x is 0 or 1 and R² is a C₂-C₄-alkylene group which, if appropriate, has one or more substituents which are C₁-C₄-alkyl groups, or are C₁-C₄-alkoxy groups, and/or are halogen atoms, preferably chlorine atoms. Merely by way of example, mention may be made of ethylene oxide, propylene 1,2-oxide, butylene 1,2-oxide, butylene 1,3-oxide, 1,3-dioxane, 1,3-dioxolane, and 1,3-dioxepan as cyclic ethers, and also of linear oligo- or polyformals, such as polydioxolane or polydioxepan, as comonomers. It is particularly advantageous to use copolymers composed of from 99.5 to 95 mol. % of trioxane and of from 0.5 to 5 mol. %, such as from 0.5 to 4 mol. %, of one of the above-mentioned comonomers.

In one particular aspect of the present disclosure, the polyoxymethylene copolymer incorporated into the powder composition contains a relatively low amount of comonomer. For example, the polyoxymethylene copolymer can contain a comonomer, such as dioxolane, in an amount less than about 5% by weight, such as in an amount less than about 2% by weight, such as in an amount less than about 1.5% by weight, such as in an amount less than about 1% by weight, such as in an amount less than about 0.75% by weight, such as in an amount less than about 0.7% by weight. The comonomer content is generally greater than about 0.3% by weight, such as greater than about 0.5% by weight.

The polymerization can be effected as precipitation polymerization or in the melt. By a suitable choice of the polymerization parameters, such as duration of polymerization or amount of molecular weight regulator, the molecular weight and hence the MVR value of the resulting polymer can be adjusted.

The polyoxymethylene polymer incorporated into the polymer composition can have various different terminal groups or end groups depending upon the particular application and the other components contained in the composition. In one aspect, the polyoxymethylene polymer is relatively thermally stable. For instance, the polyoxymethylene polymer can contain hemiformal groups in an amount less than about 2 mol %, such as in an amount less than about 1.5 mol %, such as in an amount less than about 1 mol %, such as in an amount less than about 0.8 mol %, such as in an amount less than about 0.6 mol %.

The amount of hydroxyl end groups on the polyoxymethylene polymer can depend on whether a polyisocyanate coupling agent is present in the composition. When a polyisocyanate coupling agent is not present, for instance, the polyoxymethylene polymer can have a terminal hydroxyl group content of less than about 10 mmol/kg, such as less than about 8 mmol/kg, such as less than about 6 mmol/kg, such as less than about 4 mmol/kg.

Alternatively, the polyoxymethylene polymer can contain greater amounts of terminal hydroxyl groups. In one embodiment, the polyoxymethylene polymer has a content of terminal hydroxyl groups of at least 15 mmol/kg, such as at least 18 mmol/kg, such as at least 20 mmol/kg, such as greater than about 25 mmol/kg, such as greater than about 30 mmol/kg, such as greater than about 40 mmol/kg, such as greater than about 50 mmol/kg. The terminal hydroxyl content is generally less than about 300 mmol/kg, such as less than about 200 mmol/kg, such as less than about 100 mmol/kg. In one embodiment, the terminal hydroxyl group content ranges from 18 to 50 mmol/kg. The quantification of the hydroxyl group content in the polyoxymethylene polymer may be conducted by the method described in JP-A-2001-11143.

In addition to the terminal hydroxyl groups, the polyoxymethylene polymer may also have other terminal groups usual for these polymers. Examples of these are alkoxy groups, formate groups, acetate groups or aldehyde groups. In one aspect, the polyoxymethylene polymer can also contain terminal-NH₂ groups. According to one embodiment, the polyoxymethylene is a copolymer which comprises at least 50 mol-%, such as at least 75 mol-%, such as at least 90 mol-% and such as even at least 95 mol-% of —CH₂O— repeat units.

The polyoxymethylene polymer can have any suitable molecular weight. The molecular weight of the polymer, for instance, can be from about 4,000 grams per mole to about 100,000 g/mol. The polyoxymethylene polymer, for instance, can have a molecular weight of greater than about 10,000 g/mol, such as greater than about 15,000 g/mol, such as greater than about 20,000 g/mol, such as greater than about 30,000 g/mol, such as greater than about 40,000 g/mol, and generally less than about 90,000 g/mol.

The polyoxymethylene polymer present in the composition can generally have a melt flow index (MFI) ranging from about 0.1 to about 200 g/10 min. Melt flow is determined according to ISO 1133 at 190° C. and 2.16 kg. In one aspect, however, the polyoxymethylene polymer has a relatively low melt flow index. The lower melt flow index has been found to result in a polymer composition having a larger operating window when used in rotational molding processes. In addition, the lower melt flow rate can lead to better physical properties. For instance, the polyoxymethylene polymer can have a melt flow rate of less than about 8 g/10 min, such as less than about 5 g/10 min, such as less than about 4 g/10 min, such as less than about 3 g/10 min, such as less than about 2 g/10 min, such as less than about 1 g/10 min, and generally greater than about 0.5 g/10 min.

The polyoxymethylene polymer may be present in the polyoxymethylene polymer composition in an amount of at least 40 wt. %, such as at least 45 wt. %, such as at least 55 wt. %, such as at least 60 wt. %, such as at least 70 wt. %, such as at least 80 wt. %. The polyoxymethylene polymer can be present in an amount less than about 96% by weight, such as in an amount less than about 85% by weight, such as in an amount less than about 80% by weight, such as in an amount less than about 75% by weight.

In accordance with the present disclosure, the polyoxymethylene polymer is combined with one or more impact modifiers. More particularly, impact modifiers are selected for use in the polymer composition that are food contact grade compliant. In one aspect, the impact modifier may comprise any suitable elastomer. The elastomer, for instance, can comprise a thermoplastic polyurethane elastomer, a thermoplastic polyester elastomer, or a combination thereof. The polymer composition, in one aspect, is free of other impact modifiers, such as impact modifiers comprising a methacrylate butadiene styrene, a styrene acrylonitrile, and mixtures thereof.

In one aspect, the impact modifier is a combination of a thermoplastic polyurethane elastomer and a thermoplastic polyester elastomer. The two elastomers can be present in any suitable weight ratio. For example, the thermoplastic polyurethane elastomer and the thermoplastic polyester elastomer can be present in a weight ratio of 1:10 to 10:1, such as a weight ratio of 1:10 to 2:1, such as a weight ratio of 1:8 to 3:1.

As described above, in one embodiment, the impact modifier comprises a food contact approved thermoplastic polyurethane elastomer having particular properties. The thermoplastic polyurethane elastomer, for instance, may have a soft segment of a long-chain dial and a hard segment derived from a diisocyanate and a chain extender. In one embodiment, the polyurethane elastomer is a polyester type prepared by reacting a long-chain diol with a diisocyanate to produce a polyurethane prepolymer having isocyanate end groups, followed by chain extension of the prepolymer with a diol chain extender. Representative long-chain diols are polyester diols such as poly(butylene adipate)diol, polyethylene adipate)diol and poly(E-caprolactone)diol; and polyether diols such as poly(tetramethylene ether)glycol, poly(propylene oxide)glycol and poly(ethylene oxide)glycol. Suitable diisocyanates include 4,4′-methylenebis(phenyl isocyanate), 2,4-toluene diisocyanate, 1,6-hexamethylene diisocyanate and 4,4′-methylenebis-(cycloxylisocyanate). Suitable chain extenders are C₂-C₆ aliphatic dials such as ethylene glycol, 1,4-butanediol, 1,6-hexanedial and neopentyl glycol. One example of a thermoplastic polyurethane is characterized as essentially poly(adipic acid-co-butylene glycol-co-diphenylmethane diisocyanate).

In one embodiment, the impact modifier comprises a food contact approved thermoplastic polyester elastomer having particular properties. The impact modifier, for instance, can be a thermoplastic copolyester elastomer that comprises a thermoplastic ester ether elastomer. In one aspect, the thermoplastic polyester elastomer can be a thermoplastic copolyester elastomer that comprises a block copolymer of polybutylene terephthalate and polyether segments.

In one aspect, the impact modifier contained within the polymer composition of the present disclosure comprises a thermoplastic polyurethane elastomer, a thermoplastic polyester elastomer, or combinations thereof that has a particular hardness and melt flow rate. For instance, the impact modifier can have a Shore A hardness of greater than about 78, such as greater than about 80, such as greater than about 82, such as greater than about 84. The Shore A hardness of the impact modifier can be less than about 95, such as less than about 92, such as less than about 89, such as less than about 88, when measured according to ASTM Test D2240. The impact modifier or thermoplastic polyurethane elastomer can display a melt flow rate at 190° C. and at a load of 2.16 kg of greater than about 7 g/10 min, such as greater than about 8 g/10 min, such as greater than about 9 g/10 min, such as greater than about 10 g/10 min, such as greater than about 11 g/10 min, such as greater than about 12 g/10 min, such as greater than about 13 g/10 min, such as greater than about 14 g/10 min, such as greater than about 15 g/10 min. The melt flow rate is generally less than about 25 g/10 min, such as less than about 23 g/10 min, such as less than about 20 g/10 min, such as less than about 18 g/10 min, such as less than about 15 g/10 min.

In one embodiment, the polyoxymethylene polymer is combined with an impact modifier, such as a thermoplastic polyurethane elastomer, a thermoplastic polyester elastomer, or combination thereof, that has a melting temperature similar to the melting temperature of the polyoxymethylene polymer. For example, in one aspect, the impact modifier is selected such that the melting temperature of the impact modifier is within about 8° C., such as within about 5° C., such as within about 4° C., such as within about 3° C. of the melting temperature of the polyoxymethylene polymer. For example, an impact modifier, such as a polyurethane elastomer, a thermoplastic polyester elastomer, or combination thereof, can be selected with a melting temperature of from about 150° C. to about 185° C., such as from about 158° C. to about 172° C., such as from about 163° C. to about 169° C. Melting temperature can be determined according to ISO Test 11357-1/-3 (10° C./min) or can be determined according to ASTM Test D3417 (DSC).

In one embodiment, an impact modifier, such as a thermoplastic polyurethane elastomer, a thermoplastic polyester elastomer, or combination thereof, can be selected that has a melting temperature that is less than the melting temperature of the polyoxymethylene polymer. For instance, the melting temperature of the impact modifier can be less than about 166° C.

In general, one or more impact modifiers may be present in the polymer composition in an amount from about 2% by weight to about 45% by weight, such as from about 4% by weight to about 27% by weight, including all increments of 1% by weight therebetween. For instance, one or more impact modifiers can be present in the polymer composition in an amount greater than about 6% by weight, such as in an amount greater than about 8% by weight, such as in an amount greater than about 10% by weight, such as in an amount greater than about 12% by weight, such as in an amount greater than about 14% by weight, such as in an amount greater than about 16% by weight, such as in an amount greater than about 20% by weight, such as in an amount greater than about 25% by weight, such as in an amount greater than about 30% by weight, such as in an amount greater than about 35% by weight, and generally in an amount less than about 50% by weight, such as less than about 40% by weight, such as less than about 25% by weight, such as in an amount less than about 23% by weight.

In addition to a polyoxymethylene polymer and one or more impact modifiers, the polymer composition of the present disclosure can contain various other components. For instance, in one embodiment, a plasticizer, such as a polyalkylene glycol, can be incorporated into the polymer composition for providing various advantages and benefits. The polyalkylene glycol, for instance, can improve flow properties of the particles and/or can improve impact strength resistance.

Polyalkylene glycols particularly well suited for use in the polymer composition include polyethylene glycols, polypropylene glycols, and mixtures thereof.

The molecular weight of the polyalkylene glycol can vary depending upon various factors including the characteristics of the polyoxymethylene polymer and the process conditions for producing shaped articles. In one aspect, the polyalkylene glycol, such as the polyethylene glycol, can have a relatively low molecular weight. For example, the molecular weight can be less than about 10,000 g/mol, such as less than about 8,000 g/mol, such as less than about 6,000 g/mol, such as less than about 4,000 g/mol, and generally greater than about 1000 g/mol, such as greater than about 2000 g/mol. In one embodiment, a polyethylene glycol plasticizer is incorporated into the polymer composition that has a molecular weight of from about 2000 g/mol to about 5000 g/mol.

When present in the polymer composition, the polyalkylene glycol can be added in amounts greater than about 0.1% by weight, such as in an amount greater than about 0.3% by weight. The polyalkylene glycol can generally be present in the polymer composition in an amount less than about 5% by weight, such as in an amount less than about 3% by weight, such as in an amount less than about 1% by weight.

Although a plasticizer, such as polyethylene glycol, can provide various advantages in some applications, in other applications the polymer composition can be formulated so as not to contain any plasticizers. For instance, the polymer composition can be formulated so as to be free of polyethylene glycol. Formulating the composition without a plasticizer, such as polyethylene glycol, may enhance the mechanical properties of the composition, especially impact strength.

In one embodiment, the polymer composition may contain an acid scavenger. The acid scavenger can comprise a carboxylic acid salt. For instance, the carboxylic acid salt may comprise a salt of a fatty acid, such as a metal salt of a fatty acid. For example, the carboxylic acid salt may comprise an alkaline earth metal salt of a fatty acid. The cation of the salt, for instance, may comprise calcium, barium, lithium, sodium, magnesium, zinc, or the like.

The fatty acid can contain a carbon chain of generally from about 3 carbon atoms to about 20 carbon atoms. The fatty acid may comprise a dicarboxylic acid or a tricarboxylic acid.

In one embodiment, the metal salt of the fatty acid may comprise a metal salt of citric acid, propionic acid, stearic acid, butanoic acid, hexanoic acid, decanoic acid, lauric acid, myristic acid, palmitic acid, and the like. In one particular embodiment, the metal salt of the fatty acid may comprise calcium propionate, calcium 12-hydroxystearate, a calcium citrate such as tricalcium citrate, and mixtures thereof. In one embodiment, when the polyoxymethylene polymer composition includes one or more coloring agents, various benefits and advantages are obtained by combining the coloring agents with calcium propionate.

One or more carboxylic acid salts are generally present in the polymer composition in an amount greater than about 0.001% by weight, such as in an amount greater than about 0.01% by weight, such as in an amount greater than about 0.08% by weight, such as in an amount greater than about 0.1% by weight, such as in an amount greater than about 0.12% by weight, such as in an amount greater than about 0.14% by weight. One or more carboxylic acid salts are generally present in the polymer composition in an amount less than about 5% by weight, such as in an amount less than about 3% by weight, such as in an amount less than about 2% by weight, such as in an amount less than about 1.5% by weight, such as in an amount less than about 1% by weight.

In one aspect, the polymer composition contains at least two acid scavengers. For instance, the polymer composition may contain a combination of a calcium citrate, such as tricalcium citrate, with calcium propionate. The calcium citrate can be present in relation to the calcium propionate at a weight ratio of from about 1:1 to about 1:5, such as from about 1:1.5 to about 1:3. For instance, in one particular embodiment, the polymer composition may contain a tricalcium citrate in an amount of from about 0.01% by weight to about 0.08% by weight and may contain a calcium propionate anhydrous in an amount from about 0.7% by weight to about 1.3% by weight.

In one aspect, the amount of acid scavengers contained in the polymer composition can be minimized. For instance, the polymer composition can contain one or more acid scavengers or calcium salts, in an amount less than about 0.1% by weight, such as in an amount less than about 0.08% by weight, such as in an amount less than about 0.06% by weight, and in an amount greater than about 0.01% by weight.

In one embodiment, a nucleant may be present. The nucleant may increase crystallinity and may comprise an oxymethylene terpolymer. In one particular embodiment, for instance, the nucleant may comprise a terpolymer of butanediol diglycidyl ether, ethylene oxide, and trioxane. Alternatively, the nucleant may comprise a mineral nucleant, such as talc particles. The nucleant may be present in the composition in an amount of at least about 0.01 wt. %, such as at least about 0.05 wt. %, such as at least about 0.1 wt. % and less than about 2 wt. %, such as less than about 1.5 wt. %, such as less than about 1 wt. %, wherein the weight is based on the total weight of the respective polymer composition.

In the past, many conventional polymer compositions containing polyoxymethylene polymers contained formaldehyde scavengers. Conventional formaldehyde scavengers were typically a nitrogen-containing compound. Mainly, of these are heterocyclic compounds having at least one nitrogen atom as hetero atom which is either adjacent to an amino-substituted carbon atom or to a carbonyl group, for example pyridine, pyrimidine, pyrazine, pyrrolidone, aminopyridine and compounds derived therefrom. Compounds of this nature are aminopyridine and compounds derived therefrom.

Particular examples of formaldehyde scavengers used in the past include guanamine, urea, melamine, and derivatives thereof. In accordance with the present disclosure, however, the polymer composition can be formulated so as to be free of any of the above described formaldehyde scavengers or contain one or more of the above formaldehyde scavengers at relatively low levels. For instance, a nitrogen-containing formaldehyde scavenger, such as urea, melamine, or guanamine, can be present in the composition in an amount less than about 0.5% by weight, such as in an amount less than about 0.4% by weight. In one aspect, however, the polymer composition is formulated to be urea-free, melamine-free, and/or guanamine-free.

In one embodiment, for instance, the formaldehyde scavenger may comprise a polyamide, particularly a copolyamide. Such scavengers are melamine free. The copolyamide can be present in relatively minor amounts, such as in an amount less than about 1% by weight, such as in an amount less than about 0.5% by weight, such as in an amount less than about 0.3% by weight, such as in an amount less than about 0.1% by weight, and in an amount greater than about 0.0001% by weight, such as in an amount greater than about 0.01% by weight.

Still another additive that may be present in the composition is a sterically hindered phenol compound, which may serve as an antioxidant. Examples of such compounds, which are available commercially, are pentaerythrityl tetrakis[3-(3,5-di-tert-butyl-4-hydroxyphenyl)propionate] (IRGANOX® 1010, BASF), triethylene glycol bis[3-(3-tert-butyl-4-hydroxy-5-methylphenyl)propionate] (IRGANOX® 245, BASF), 3,3′-bis[3-(3,5-di-tert-butyl-4-hydroxyphenyl)propionohydrazide] (IRGANOX® MD 1024, BASF), hexamethylene glycol bis[3-(3,5-di-cert-butyl-4-hydroxyphenyl)propionate] (IRGANOX® 259, BASF), and 3,5-di-tert-butyl-4-hydroxytoluene (LOWINOX® BHT, Chemtura). The above compounds may be present in the polymer composition in an amount ranging from about 0.01% by weight to about 1% by weight based on the total weight of the polymer composition. In one aspect, one or more hindered phenol antioxidants can be present in the polymer composition in an amount greater than about 0.2% by weight, such as in an amount greater than about 0.24% by weight, such as in an amount greater than about 0.28% by weight.

In one embodiment, a lubricant may be present. The lubricant can comprise a polymer wax composition. For example, a fatty acid amide may be used. One example of a fatty acid amide is ethylene bis(stearamide). Alternatively, the lubricant can comprise a polyethylene wax. Lubricants may generally be present in the polymer composition in an amount from about 0.01% by weight to about 1% by weight.

In addition to limiting the amount of particular formaldehyde scavengers, the polymer composition of the present disclosure can also be formulated so as to be free of various other components. For instance, in one embodiment, the composition does not contain any coupling agents, particularly isocyanate coupling agents. In addition, the composition can be formulated to be free of ultraviolet light stabilizers. In this regard, the composition can be formulated not to contain any benzophenones, benzotriazoles, or benzoates. In one aspect, the composition can also be formulated so as to be free of sterically hindered amine light stabilizers. For instance, the composition can be formulated to be free of sebacates.

Alternatively, the composition can contain one or more ultraviolet light stabilizers. Ultraviolet light stabilizers, for instance, can be incorporated into the composition while still remaining suitable for food contact applications. The ultraviolet light stabilizer may comprise a benzophenone, a benzotriazole, or a benzoate. The ultraviolet light stabilizer can be selected from the group consisting of 2-hydroxy-phenylbenzotriazole or its derivatives, hydroxbenzophenone or its derivatives and 2-hydroxyphenyltriazine and its derivatives. An especially preferred ultraviolet light stabilizer is 2-[2-hydroxy-3,5-di-(1,1-dimethylbenzyl)]-2H-benzotriazole. The UV light absorber, when present, may be present in the polymer composition in an amount of at least about 0.01 wt. %, such as at least about 0.05 wt. %, such as at least about 0.075 wt. % and less than about 1 wt. %, such as less than about 0.75 wt. %, such as less than about 0.5 wt. %, wherein the weight is based on the total weight of the respective polymer composition.

The light stabilizer can also comprise a hindered amine light stabilizer. Examples of hindered amine light stabilizers include bis(2,2,6,6-tetramethyl-4-piperidyl) sebacate, poly[[6-[(1,1,3,3-tetramethylbutyl)amino]-1,3,5-triazine-2,4-diyl] [2,2,6,6-tetramethyl-4-piperidyl]imino]hexamethylene [2,2,6,6-tetramethyl-4-piperidyllimino], methyl 1,2,2,6,6-pentamethyl-4-piperidinyl sebacate, and bis(1-octyloxy-2,2,6,6-tetramethyl-4-piperidyl) sebacate. One or more hindered light stabilizers may be present in the polymer composition in an amount of at least about 0.01 wt. %, such as at least about 0.05 wt. %, such as at least about 0.075 wt. % and less than about 1 wt. %, such as less than about 0.75 wt. %, such as less than about 0.5 wt. %, wherein the weight is based on the total weight of the respective polymer composition.

In one embodiment, one or more coloring agents can also be added to the polymer composition. The coloring agent can be a pigment or a dye. In one aspect, the coloring agent can be added as a masterbatch in combination with a carrier polymer. Various different types of carrier polymers can be used. In one aspect, for instance, the carrier polymer can comprise a polyolefin polymer, such as a polyethylene polymer. The polyethylene polymer, for instance, can comprise a linear low density polyethylene. Alternatively, the carrier polymer can comprise polyoxymethylene polymer. One or more coloring agents can be present in the polymer composition generally in an amount greater than about 0.1% by weight and generally in an amount less than about 2% by weight. For instance, one or more coloring agents can be present in the polymer composition in an amount less than about 1.5% by weight, such as in an amount less than about 1% by weight, such as in an amount less than about 0.8% by weight, such as in an amount less than about 0.6% by weight, and in an amount greater than about 0.1% by weight.

When adding a coloring agent, the use of a masterbatch in combination with a carrier polymer can be preferred in various applications. The carrier polymer, for instance, can help disperse the coloring agent for improving the mechanical properties of the polymer composition and facilitating color fade resistance. The carrier polymer, for instance, can be present in relation to the coloring agent at a weight ratio of from about 0.5:1 to about 100:1, such as from about 1:1 to about 50:1.

In one aspect, a masterbatch containing a coloring agent can be incorporated into the polymer composition in an amount greater than about 1% by weight, such as in an amount greater than about 2% by weight, such as in an amount greater than about 4% by weight, such as in an amount greater than about 8% by weight, such as in an amount greater than about 10% by weight, such as in an amount greater than about 15% by weight, and in an amount less than about 25% by weight, such as in an amount less than about 20% by weight, such as in an amount less than about 15% by weight. The coloring agent can be contained in the masterbatch in an amount from about 1% by weight to about 50% by weight, such as from about 2% by weight to about 30% by weight, such as from about 3% by weight to about 25% by weight. For instance, the carrier polymer can be present in the masterbatch in an amount greater than about 50% by weight, such as in an amount greater than about 60% by weight, such as in an amount greater than about 70% by weight, such as in an amount greater than about 80% by weight, such as in an amount greater than about 90% by weight, such as in an amount greater than about 94% by weight, such as in an amount greater than about 96% by weight, and in an amount less than about 99.9% by weight, such as in an amount less than about 90% by weight, such as in an amount less than about 70% by weight.

In one aspect, the coloring agents incorporated into the composition are selected so as to be food contact grade compliant. For example, examples of coloring agents that can be incorporated into the composition include but are not limited to, Sicotan Yellow K 2112, Kronos 2220, Kronos 2211, Kronos 2233, Printex FP, PV Fast Green GNX, PV Fast Yellow HG, Irgazin Yellow K 2070, Bayferrox 3910, Irgazin Red K 3840, Cromophtal Orange GP, Heliogen Blue K 7090, and Heliogen Green K 8730. Specifically disclosed pigments are to be understood as merely representative examples of the variety of pigments that may be used.

Sicotan Yellow K 2112, a rutile pigment based on chromium III oxide, antimony pentoxide, and titanium dioxide. Any acid-soluble antimony is present in an amount less than about 20 ppm. Additionally, unavoidable impurities are suppressed to 30 ppm arsenic, 50 ppm lead, less than 10 ppm cadmium, less than 10 ppm cobalt, less than 10 ppm copper, less than 50 ppm nickel, less than 1 ppm selenium, less than 1 ppm mercury, and less than 100 ppm zinc. Sicotan Yellow K 2112 complies with or otherwise is permitted by the following rules and regulations: EU regulation no 1935/2004/EC-Art. 3, AP (89) 1, Germany BfR IX, and Australian regulation AS 2070-1999, being conditionally compliant with use restrictions under EU (EC) Regulation 10/2011, France Brochure 1227, Spain Real Decreto 847/2011, Italy Decreto 21/3/73, FDA 21 CFR, Japan JHOSPA, and Chinese regulation GB9685-2008. The pigment does not comply with Japan JHPA.

Kronos 2211, 2220, and 2233 are representative of rutile pigments produced by a chloride process, representative of R2 compounds corresponding to DIN EN ISO 591 part 1, containing, respectively, a minimum 95.5, 92.5, and 96 wt. % TiO₂ and are stabilized, respectively, with compounds containing aluminum, aluminum with silicon, and aluminum with silicon. The scattering power of a plastisol formulation containing the same may be, respectively, approximately 105, 99, and 104. Various grades of titanium dioxide may be employed depending on the target design needs. For example, Kronos 2233 is a titanium dioxide which resists degradation of the carrier polymer and maintains tinting effects even at high processing temperatures.

Printex FP is representative of a pigment black 7 (color index #77266) compliant with 21 CFR § 178.3297. Other black pigments that can be used include carbon black and graphite particles.

PV Fast Green GNX is representative of a pigment green 7 (copper phthalocyanine) which is FDA compliant under 21 CFR § 178.3297 without limitation.

PV Fast Yellow HG is representative of a pigment yellow 180 (benzimidazolone) which is FDA compliant under 21 CFR § 176.170 for applications wherein the food contacting surface meets conditions of use B, C, D, E, F, G from Table 2. The pigment has not been declared compliant for applications meeting conditions of use A or H.

Irgazin Yellow K 2070 is representative of a pigment yellow 110 (isoindolinone) and complies with or otherwise is permitted by the following rules and regulations: EU regulation no 1935/2004/EC-Art. 3, EU (EC) Regulation 10/2011, AP (89) 1, Germany BfR IX, Spain Real Decreto 847/2011, Italy Decreto 21/3/73, Australian regulation AS 2070-1999, and Chinese regulation GB9685-2008, being conditionally compliant with use restrictions under France Brochure 1227, FDA 21 CFR, and Japan JHOSPA and JHPA.

Bayferrox 3910 is representative of a pigment yellow 42 (iron oxide yellow: FeO(OH)·xH₂O). Not more than 3 ppm arsenic, 1 ppm cadmium, 10 ppm lead, or 1 ppm mercury is lost on drying of the pigment, and the pigment complies with or otherwise is permitted by the following rules and regulations: EU AP (89) 1, Germany BfR IX, France Circulaire 176 dated 2 Dec. 1959, Netherlands Warenwet/Regeling Verpakkingen; Uitvoeringsvoorschriften CIII-55, Spain Resolucion date 4.1L1982 in accordance with Art. 5 of Royal Decree 211/1992, Australian AS 2070.6, USA 21 CFR 178.3297, and Japan JHOSPA.

Irgazin Red K 3840 is representative of a pigment red 254 (diketopyrrolopyrrole) and complies with or otherwise is permitted by the following rules and regulations: EU regulation no 1935/2004/EC-Art. 3, EU (EC) Regulation 10/2011, AP (89) 1, Germany BIR IX, France Brochure 1227, Spain Real Decreto 847/2011, Italy Decreto 21/3/73, and Australian regulation AS 2070-1999, being conditionally compliant with use restrictions under FDA 21 CFR, Japan JHOSPA and JHPA, and Chinese regulation GB9685-2008.

Cromophtal Orange GP is representative of a pigment orange 64 (disazo condensation) and complies with or otherwise is permitted by the following rules and regulations: EU regulation no 1935/2004/EC-Art. 3, EU (EC) Regulation 10/2011, AP (89) 1, Germany BfR IX, France Brochure 1227, Spain Real Decreto 847/2011, Italy Decreto 21/3/73, and Australian regulation AS 2070-1999, being conditionally compliant with use restrictions under FDA 21 CFR, Japan JHOSPA, and Chinese regulation GB9685-2008.

Heliogen Blue K 7090 is representative of a pigment blue 15:3 or unchlorinated copper phthalocyanine (beta form with approx. 11 wt. % copper) and complies with or otherwise is permitted by the following rules and regulations: EU regulation no 1935/2004/EC-Art. 3, AP (89) 1, Germany BfR IX, Japan JHPA, and Australian regulation AS 2070-1999, being conditionally compliant with use restrictions under EU (EC) Regulation 10/2011, France Brochure 1227, Spain Real Decreto 847/2011, Italy Decreto 21/3/73, FDA 21 CFR, Japan JHOSPA, and Chinese regulation GB9685-2008. Unavoidable impurities are suppressed to less than 20 ppm antimony, less than 20 ppm arsenic, less than 20 ppm lead, less than 30 ppm cadmium, less than 50 ppm chromium, less than 20 ppm selenium, less than 20 ppm mercury, and less than 20 ppm zinc. Any primary aromatic amines are also suppressed to less than 100 ppm.

Heliogen Green K 8730 is representative of pigment green 7 or a chlorinated copper phthalocyanine (with approx. 5.6 wt. % copper) and complies with or otherwise is permitted by the following rules and regulations: AP (89) 1, being conditionally compliant with use restrictions under EU regulation no 1935/2004/EC-Art. 3, EU (EC) Regulation 10/2011, Germany BfR IX, France Brochure 1227, Spain Real Decreto 847/2011, Italy Decreto 21/3/73, FDA 21 CFR, Japan JHOSPA, Japan JHPA, Australian regulation AS 2070-1999, and Chinese regulation GB9685-2008. Unavoidable impurities are suppressed to less than 20 ppm antimony, less than 20 ppm arsenic, less than 20 ppm lead, less than 30 ppm cadmium, less than 50 ppm chromium, less than 20 ppm selenium, less than 20 ppm mercury, and less than 20 ppm zinc. Any primary aromatic amines are also suppressed to less than 100 ppm.

In order to form a powder from the polymer composition of the present disclosure, in one aspect, the components of the polymer composition can be mixed together and then melt blended. For instance, the components can be melt blended in an extruder. Processing temperatures can vary depending upon the type of polyoxymethylene polymer chosen for use in the application. In one embodiment, processing temperatures can be from about 165° C. to about 200° C.

Extruded strands can be produced which are then pelletized. The pelletized compound can then be ground to a suitable particle size and to a suitable particle size distribution to produce a powder that is well suited for use in rotational molding.

For example, any suitable hammermill or granulator may be used to produce the powder composition. In one embodiment, cryogenic grinding is used to produce particles having a relatively small size and a uniform particle size distribution. Cryogenic grinding, for instance, can produce a powder not only having a uniform size but also having particles that are approximately spherical in shape.

Once the polymer composition is formulated and formed into a powder having a controlled particle size distribution, the polymer particles are loaded into a mold for producing molded articles. The polymer particles are particularly well suited for use in rotational molding processes. During rotational molding, the polymer particles are loaded into a mold and the mold is rotated at least about a first axis and a second axis while being heated. The polymer composition is heated to a molten temperature, causing the polymer composition to flow and coat the interior walls of the mold for producing hollow vessels.

Of particular advantage, the polymer composition of the present disclosure containing the polyoxymethylene polymer can be incorporated into a rotational molding application using conventional equipment without modification. For instance, the polymer particles of the present disclosure can be formulated to have a bulk density and flowability characteristics that are well suited for rotational molding. For example, the particles can display a funnel flow when tested according to the A.R.M. Funnel Test (100 grams) of less than about 35 seconds, such as less than about 30 seconds, such as less than about 25 seconds, such as less than about 20 seconds, and generally greater than about 5 seconds. The particles can have an untapped bulk density of greater than about 0.37 g/cc, such as greater than about 0.4 g/cc, such as greater than about 0.42 g/cc, and generally less than about 0.6 g/cc.

When producing rotationally molded articles, no pre-drying of the powder is necessary and the use of nitrogen is not necessary during molding. In addition, the polymer composition of the present disclosure can easily release from the mold after cooling requiring no special coatings or tools. The polymer composition of the present disclosure also shows excellent flow properties even when molding intricate designs.

Rotationally molded articles can be produced according to the present disclosure at relatively fast cycle times. For instance, at oven temperatures of from about 400° F. to about 450° F., a rotationally molded article having a wall thickness of 3.8 mm can be produced in less than about 20 minutes, such as less than about 18 minutes, and generally greater than about 10 minutes, such as greater than about 15 minutes. At a wall thickness of 5.1 mm, articles can be produced in generally less than about 25 minutes, such as less than about 21 minutes, and generally at times greater than about 12 minutes, such as greater than about 18 minutes. Air cooling times are generally less than about 30 minutes. For instance, when rotated in air, the cooling time can be from about 0 to about 10 minutes. When rotated in forced air, the cooling time can be from about 10 minutes to about 20 minutes.

Thus, rotationally molded articles can be produced in accordance with the present disclosure being made from a single layer of material having a wall thickness of from about 3.8 mm to about 5.1 mm in a total cycle time (heating and cooling) of less than about 60 minutes, such as less than about 51 minutes, such as less than about 45 minutes, such as less than about 30 minutes, and generally greater than about 15 minutes.

All different types of rotationally molded articles can be made in accordance with the present disclosure. In general, rotationally molded articles generally include an interior hollow space. Thus, the polymer composition of the present disclosure is particularly well suited for producing containers for foodstuffs. The container can be, for instance, a food tote, a food bin, or any suitable food container that is designed to be stored at room temperature, in a refrigerator, or in a freezer.

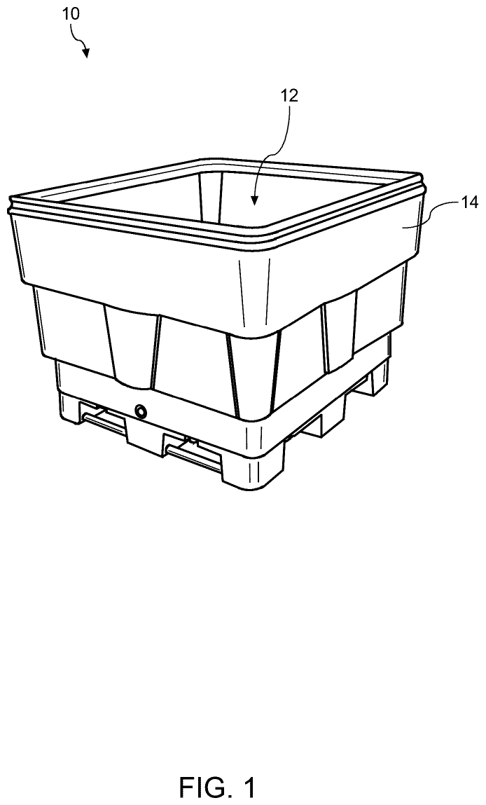

Referring to FIG. 1, one embodiment of a food container 10 made in accordance with the present disclosure is shown. In this embodiment, the food container 10 is a food tote having a relatively large holding capacity. The food tote 10 includes an interior hollow space 12 defined by and surrounded by a plurality of container walls 14. In one aspect, the container walls 14 can be made from a single layer of the polymer composition. In addition, the container 10 can be seamless which can dramatically improve the strength, especially the impact resistance strength of the container.

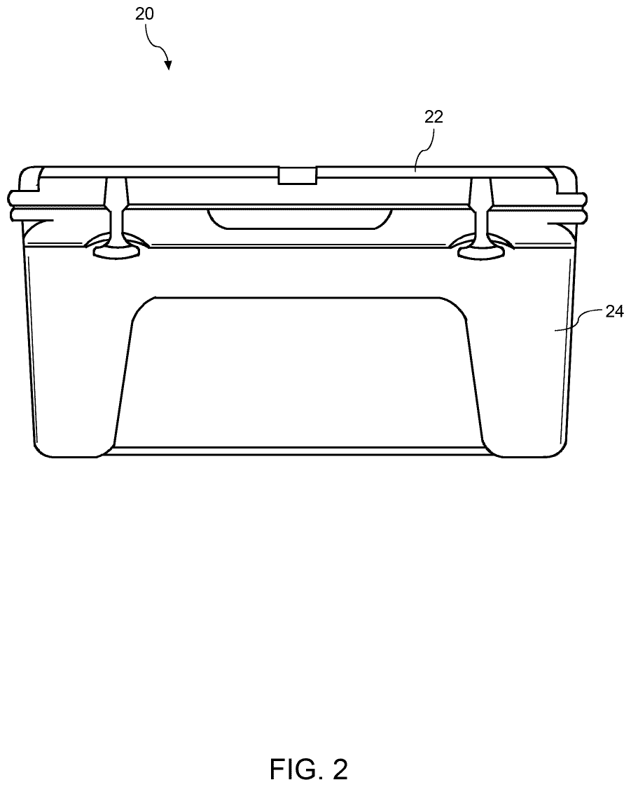

Referring to FIG. 2, another embodiment of a food container 20 made in accordance with the present disclosure is shown. In this embodiment, the food container 20 is a food bin. The food bin 20 includes a lid 22 that is pivotally attached to a container body 24. The container body 24 defines an interior volume and is formed from one or more container walls.

Rotomolded containers made according to the present disclosure can be formed with low voids and therefore with a high density. The density of the polymer layer used to form the container can be greater than about 1250 kg/m³, such as greater than about 1260 kg/m³, such as greater than about 1270 kg/m³, such as greater than about 1280 kg/m³, such as greater than about 1290 kg/m³, such as greater than about 1300 kg/m³, such as greater than about 1310 kg/m³, such as greater than about 1350 kg/m³, and generally less than about 2000 kg/m³, such as less than about 1450 kg/m³, when containing an impact modifier.

In one embodiment, the container can have a relatively small volume. For instance, the container can have a volume of less than about 10 gallons, such as less than about 5 gallons, such as less than about 4 gallons, such as less than about 2 gallons, and generally greater than about 0.1 gallons. Alternatively, larger tanks can be produced. For instance, the tank can have a volume of greater than about 10 gallons, such as greater than about 15 gallons, such as greater than about 20 gallons, such as greater than about 50 gallons, such as greater than about 100 gallons, such as greater than about 150 gallons, such as greater than about 200 gallons, and generally less than about 600 gallons, such as less than about 500 gallons, such as less than about 400 gallons.

The polymer composition of the present disclosure and rotationally molded articles made in accordance with the present disclosure can have an excellent balance of mechanical properties. The polymer composition can display a Charpy notched impact strength at 23° C. of greater than about 9 kJ/m², such as greater than about 10 kJ/m², such as greater than about 12 kJ/m², such as greater than about 14 kJ/m², such as greater than about 16 kJ/m², such as greater than about 18 kJ/m², and generally less than about 90 kJ/m². Charpy notched impact strength can be measured according to ISO Test 179 using an injection molded specimen.

Containers made according to the present disclosure can also be tested for multiaxial impact strength according to ARM low temperature impact test (V4) at 23° C. (t=3 mm). The multiaxial impact strength can be greater than about 5 ft-lbs, such as greater than about 7.5 ft-lbs, such as greater than about 9 ft-lbs, such as greater than about 10 ft-lbs, such as greater than about 12 ft-lbs, such as greater than about 14 ft-lbs, such as greater than about 16 ft-lbs, such as greater than about 18 ft-lbs, such as greater than about 20 ft-lbs, such as greater than about 22 ft-lbs, and generally less than about 100 ft-lbs.

The polymer composition can display a tensile yield strength when tested according to ISO Test 527 of greater than about 30 MPa, such as greater than about 35 MPa, such as greater than about 38 MPa, and generally less than about 80 MPa.

The polymer composition can display a relatively high heat deflection temperature. For instance, the polymer composition can display a heat deflection temperature at 0.45 MPa according to ISO Test 75 of greater than about 100° C., such as greater than about 110° C., such as greater than about 120° C., such as greater than about 130° C., and generally less than about 160° C. When tested at 1.8 MPa, the heat deflection temperature can be greater than about 60° C., such as greater than about 62° C., such as greater than about 64° C., such as greater than about 66° C., such as greater than about 68° C., and less than about 90° C.

The present disclosure may be better understood with reference to the following examples.

### Example No. 1

A polymer composition was formulated in accordance with the present disclosure and tested for various properties. The polymer composition contained a food grade compliant polyoxymethylene polymer combined with a food grade compliant thermoplastic elastomer. The thermoplastic elastomer was a thermoplastic polyurethane polyester-type elastomer. The thermoplastic elastomer had a Shore A hardness of from about 85 to about 87 when tested according to ASTM Test D2240 and had a melt flow rate of 50 g/10 min when tested at 190° C. and at a load of 8.7 kg according to ISO Test 1131-1. The polymer composition was formulated so as not to contain any UV stabilizers or coupling agents. In addition, the amount of antioxidant was relatively high in formulating the composition. Once the ingredients were extruded together, a powder was formed having an average particle size of 500 microns (35 mesh). The formulation tested was as follows:

| | Weight % |
|---|---|
| Material | Sample No. 1 |
| Polyoxymethylene polymer | 80.27% |
| (2.5 g/10 min - low amount of hydroxyl groups) | |
| Thermoplastic polyurethane | 18% |
| Polyoxymethylene resin | 3.502% |
| Polyethylene glycol | 0.50% |
| Calcium propionate anhydrous | 0.10% |
| Hindered phenolic antioxidant | 0.3% |
| Melamine | 0.03% |
| Copolyamide | 0.05% |
| Tricalcium citrate | 0.05% |
| Oxymethylene terpolymer nucleating | 0.5% |
| agent | |

The composition was tested for various physical properties and the following results were obtained.

| | | | Sample |
|---|---|---|---|
| Process | Property | Test Method | No. 1 |
| Injection | Density | ISO 1183 | 1350 |
| Molding | (kg/m\hat{ }3) | | |
| | Tensile Yield | ISO 527 | 41 |
| | Strength, | | |
| | 50 mm/min | | |
| | (MPa) | | |
| | Flexural | ISO 178 | 1525 |
| | Modulus, 23° C. | | |
| | (MPa) | | |
| | Charpy | ISO 179 | 10.8 |
| | Notched | | |
| | Impact | | |
| | strength, 23° C. | | |
| | (kJ/m\hat{ }2) | | |
| | DTUL @ 1.80 | ASTM D648 | 68 |
| | MPa (° C.) | | |
| | DTUL @ 0.455 | ASTM D648 | 135 |
| | MPa (° C.) | | |
| Roto- | Density | ISO 1183 | 1300 |
| molding | (kg/m\hat{ }3) | | |
| | Multiaxial | ARM Low | 8 |
| | impact @ 23° C. | Temperature | |
| | Mean Failure | | |
| | Energy (ft-lbs), | Impact Test | |
| | t = 3 mm | (V4) | |

The composition formulated above was compared to a food contact compliant polypropylene composition. The polypropylene composition only had a density of 0.9 g/cc, a tensile yield strength of 24 MPa, and a flexural modulus of 1150 MPa. The polypropylene composition also only displayed a heat deflection temperature at 0.45 MPa of 90° C. and at 1.8 MPa of 50° C. The polypropylene composition also only displayed a Charpy notched impact strength resistance at 23° C. of 8.2 kJ/m².

### Example No. 2

Further polymer compositions were formulated in accordance with the present disclosure and tested for various properties similar to the process and procedures described in Example No. 1.

The following polymer compositions were formulated and tested:

| | Sample | Sample | Sample | Sample | Sample | Sample | Sample |
|---|---|---|---|---|---|---|---|
| Specific Variations of the | No. 2 | No. 3 | No. 4 | No. 5 | No. 6 | No. 7 | No. 8 |
| Material | Weight % | | | | | | |
| Polyoxymethylene Polymer | 61.7% | 68.61% | 65.47% | 75.07% | 68.61% | | 74.37% |
| (2.5 g/10 min - low amount | | | | | | | |
| of hydroxyl groups) | | | | | | | |
| Polyoxymethylene Polymer | | | | | | 68.44% | |
| (9 g/10 min) | | | | | | | |
| Thermoplastic | 10% | 10% | 10% | 10% | 10% | 10% | 10% |
| Polyurethane | | | | | | | |
| Copolyester elastomer | 10% | 10% | 10% | 10% | 10% | 10% | 10% |
| Polyoxymethylene | 0.5% | 0.5% | 0.5% | 0.5% | 0.5% | 0.5% | 0.5% |
| terpolymer nucleating agent | | | | | | | |
| Hindered phenolic | 0.24% | 0.23% | 0.23% | 0.23% | 0.23% | 0.4% | 0.23% |
| antioxident | | | | | | | |
| Polyethylene glycol | 0.75% | | | | | | |
| Copolyamide | 0.05% | 0.05% | 0.05% | 0.05% | 0.05% | 0.05% | 0.05% |
| TriCalcium Citrate | 0.05% | 0.05% | 0.05% | 0.05% | 0.05% | 0.05% | 0.05% |
| Melamine | 0.04% | | | | | | |
| Calcium Propionate | 0.15% | | | | | | |
| Anhydrous | | | | | | | |
| UV stabilizer - | 0.45% | 0.3% | 0.3% | 0.3% | 0.3% | 0.3% | 0.3% |
| Benzotriazole | | | | | | | |
| UV stabilizer - Hindered | 0.45% | 0.3% | 0.3% | 0.3% | 0.3% | 0.3% | 0.3% |
| Amine Light Stabilizer | | | | | | | |
| Polyoxymethylene polymer | 13.423% | 7.76% | | | | | |
| (9 g/10 min) | | | | | | | |
| Polyoxymethylene Polymer | | | | | 7.76% | 7.76% | |
| Ethylene bis stearamide | 0.2% | 0.2% | 0.2% | 0.2% | 0.2% | 0.2% | 0.2% |
| Carbon black containing | 2.0% | 2.0% | | | | | |
| 75% by weight carrier | | | | | | | |
| polymer | | | | | | | |
| Carbon black containing | | | | | 2.0% | 2.0% | |
| 75% by weight carrier | | | | | | | |
| polymer | | | | | | | |
| Graphite flake containing | | | | | | | 4% |
| 87.5% by weight carrier | | | | | | | |
| polymer | | | | | | | |
| Carbon black containing | | | 12.9% | | | | |
| 96% by weight | | | | | | | |
| polyoxymethylene carrier | | | | | | | |
| polymer | | | | | | | |
| Carbon black containing | | | | 3.3% | | | |
| 85% by weight | | | | | | | |
| polyethylene carrier | | | | | | | |
| polymer | | | | | | | |

The above compositions displayed the following properties:

| | Sample | Sample | Sample | Sample | Sample | Sample | Sample |
|---|---|---|---|---|---|---|---|
| Property | No. 2 | No. 3 | No. 4 | No. 5 | No. 6 | No. 7 | No. 8 |
| Density(g/cc) | 1.337 | 1.3417 | 1.3299 | 1.3258 | 1.3407 | 1.3440 | 1.3554 |
| ISO 1183 | | | | | | | |
| Tensile Yield | 31 | 40 | 36 | 38 | 40 | 40 | 38 |
| Strength (MPa) | | | | | | | |
| ISO 527 | | | | | | | |
| Flexural Modulus | 1398 | 1418 | 1274 | 1319 | 1387 | 1524 | 1491 |
| (MPa) ISO 178 | | | | | | | |
| Heat Deflection | 128.4 | 130.4 | 114.2 | 123.4 | 118.9 | 133.5 | 125.6 |
| Temperature @ | | | | | | | |
| 0.45 MPa (° C.) | | | | | | | |
| ISO 75 | | | | | | | |
| HDT @ 1.80 MPa | 68.1 | 65.5 | 61.2 | 64.5 | 66.3 | 69.3 | 64.6 |
| (° C.) ISO 75 | | | | | | | |
| Charpy notched | 12.2 | 13.7 | 12.2 | 14.9 | 14.5 | 9.1 | 12.7 |
| 23° C. (kJ/m\hat{ }2) | | | | | | | |
| ISO 179 | | | | | | | |
| Delta E color shift | 8.62 | | | | | | |
| (SAE J 2527 @ | | | | | | | |
| 1250 kJ/m\hat{ }2) | | | | | | | |
| Delta E color shift | | 6.6 | 3.3 | 6.8 | 4.4 | 4.7 | 16.21 |
| (SAE J 2527 @ | | | | | | | |
| 500 kJ/m\hat{ }2) | | | | | | | |
| Multiaxial Impact | 9.38 | 14.06 | 9.38 | 19.38 | 21.88 | 6.88 | 4.38 |
| (ARM method), | | | | | | | |
| thickness = 4 mm, | | | | | | | |
| 23° C. (ft-lbs) | | | | | | | |

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

What is claimed:

1. A polymer composition for rotational molding applications comprising:
polymer particles comprising a polyoxymethylene polymer blended with an impact modifier, the impact modifier comprising a thermoplastic elastomer, the polyoxymethylene polymer having a melt flow rate of less than about 5 g/10 min, the polyoxymethylene polymer being present in the polymer composition in an amount of at least about 55% by weight, the impact modifier being present in the polymer composition in an amount of from about 4% by weight to about 27% by weight, and wherein the polymer particles further comprise a nucleant and an antioxidant, the polymer particles having an average particle size of from about 250 microns to about 800 microns.

2. A polymer composition as defined in claim 1, wherein the impact modifier meets the requirements of European Food Regulation 10/2011 and FDA Food Regulation FDA 21 CFR 177.2470 Title 21 of the Code of Federal Regulations regarding food contact polymers.

3. A polymer composition as defined in claim 1, wherein the polyoxymethylene polymer has a melt flow rate of less than about 4 g/10 min and greater than about 0.5 g/10 min.

4. A polymer composition as defined in claim 1, wherein the impact modifier comprises a thermoplastic polyurethane elastomer.

5. A polymer composition as defined in claim 4, wherein the thermoplastic polyurethane elastomer has a melt flow rate of greater than about 7 g/10 min and less than about 25 g/10 min when measured at 190° C. and at a load of 2.16 kg and wherein the thermoplastic polyurethane elastomer has a melting temperature of from about 150° C. to about 180° C. and wherein the thermoplastic polyurethane elastomer has a Shore A hardness of greater than about 78 and less than about 95 when measured according to ASTM Test D2240.

6. A polymer composition as defined in claim 1, wherein the impact modifier comprises a thermoplastic polyester elastomer.

7. A polymer composition as defined in claim 6, wherein the thermoplastic polyester elastomer has a melt flow rate of greater than about 7 g/10 min and less than about 25 g/10 min when measured at 190° C. and at a load of 2.16 kg and wherein the thermoplastic polyester elastomer has a melting temperature of from about 150° C. to about 180° C. and wherein the thermoplastic polyester elastomer has a Shore A hardness of greater than about 78 and less than about 95 when measured according to ASTM Test D2240.

8. A polymer composition as defined in claim 1, wherein the impact modifier comprises a thermoplastic polyurethane elastomer, a thermoplastic polyester elastomer, or a combination thereof.

9. A polymer composition as defined in claim 1, wherein the nucleant comprises a terpolymer.

10. A polymer composition as defined in claim 1, wherein the polymer composition does not contain any ultraviolet light stabilizers.

11. A polymer composition as defined in claim 1, wherein the polymer composition further contains an acid scavenger, the acid scavenger comprising a carboxylic acid salt.

12. A polymer composition as defined in claim 11, wherein the acid scavenger comprises a calcium citrate, a calcium propionate, or mixtures thereof, the acid scavenger being present in the polymer composition in an amount from about 0.001% by weight to about 1% by weight.

13. A polymer composition as defined in claim 11, wherein one or more acid scavengers are present in the polymer composition in an amount less than about 0.08% by weight.

14. A polymer composition as defined in claim 1, wherein the polymer composition contains calcium propionate and tricalcium citrate, the calcium propionate being present in relation to the calcium citrate at a weight ratio of from about 4:1 to about 1.2:1.

15. A polymer composition as defined in claim 1, wherein the polymer composition is free of guanamine, urea, or melamine formaldehyde scavengers.

16. A polymer composition as defined in claim 1, wherein the polymer composition further contains a plasticizer and wherein the plasticizer comprises a polyethylene glycol, the polyethylene glycol being present in the polymer composition in an amount from about 0.01% by weight to about 2% by weight, such as from about 0.1% by weight to about 0.8% by weight.

17. A polymer composition as defined in claim 1, wherein the polymer composition does not contain a polyethylene glycol.

18. A polymer composition as defined in claim 1, wherein the polymer composition contains at least one coloring agent comprising a yellow coloring agent, a blue coloring agent, a red coloring agent, an orange coloring agent, a green coloring agent, a white coloring agent, a black coloring agent, or mixtures thereof.

19. A polymer composition for rotational molding applications comprising:
polymer particles comprising a polyoxymethylene polymer blended with an impact modifier, the impact modifier comprising a thermoplastic elastomer, the polyoxymethylene polymer having a melt flow rate of less than about 10 g/10 min, the polyoxymethylene polymer being present in the polymer composition in an amount of at least about 55% by weight, the impact modifier being present in the polymer composition in an amount from about 4% by weight to about 27% by weight, the polymer particles having an average particle size of from about 250 microns to about 800 microns, the polymer composition further containing a masterbatch comprising a coloring agent in combination with a carrier polymer, the coloring agent being present in the polymer composition in an amount less than about 1% by weight, the polymer composition displaying a Delta E color shift according to SAE Test J2527 at 500 kJ/m² of less than about 10.

20. A polymer composition as defined in claim 19, wherein the polymer composition displays a Delta E color shift of less than about 5 and wherein the coloring agent comprises carbon black or graphite and wherein the carrier polymer comprises a polyethylene polymer or a polyoxymethylene polymer and is present in the masterbatch in an amount from about 50% by weight to about 99% by weight.

21. A food contact article comprising:
a seamless rotationally molded food container defining an interior space for contacting food stuffs, the food container comprising a wall made from the polymer composition as defined in claim 1.

22. A food contact article as defined in claim 21, wherein the wall has a thickness of from about 0.5 mm to about 10 mm and wherein the food container has an interior volume of greater than about 3 gallons and less than about 800 gallons and wherein the wall of the food container has a density according to ISO Test 1183 of greater than 1.1 g/cc and less than about 1.6 g/cc.
